(19) United States
(12) Patent Application Publication
(10) Pub. No.: US 2009/0086257 A1
(43) Pub. Date: Apr. 2, 2009

(54) Method and system for energy saving redirection and orderly queuing of rendering jobs

(75) Inventor: Steven J. Harrington, Webster, NY (US)

Correspondence Address: ORTIZ & LOPEZ, PLLC, P. O. BOX 4484, ALBUQUERQUE, NM, 87196-4484, US

(73) Assignee: Xerox Corporation

(21) Appl. No.: 11/904,478

(22) Filed: Sep. 27, 2007

(51) Int. Cl. G06F 3/12

(52) U.S. Cl. 358/1.15

(57) ABSTRACT

A plurality of rendering devices in communication with a network are configured with an active mode and an inactive mode, wherein in the active mode a rendering device is either in a rendering state or constitutes components ready to render. In response to receiving a rendering job request, it is determined if any rendering device of the plurality of rendering devices is currently an active mode rendering device. If an active mode rendering device is available via the network, a rendering queue wait time is estimated with respect to the active mode rendering device and an activation wait time is estimated for an inactive rendering device on the network. The estimated rendering queue wait time is compared to the estimated activation wait time and the rendering job is rendered on the rendering device associated with a shorter estimated time, thereby saving energy by maintaining the majority of rendering devices in communication with the network in an inactive mode.

### TECHNICAL FIELD

Embodiments are generally related to rendering devices, such as printers, scanners, facsimile machines, copy machines and the like. Embodiments are also related to the management of multiple digital printing devices that communicate over a network. Embodiments are also related to the queuing of print jobs on a network associated with multiple printers.

### BACKGROUND

Copiers, printers, and other multifunction machines, including scanning and facsimile capabilities, are familiar in offices and homes. (As used herein, all such machines can be generically referred to as “rendering devices”) One example of a commonly utilized rendering device is a digital printer. Such a rendering mechanism typically includes both hardware and software aspects. Several of these aspects mandate that the rendering device undergo a distinct time period between the machine being turned on or otherwise requested to operate and the machine being ready to print.

It is generally known, in the office equipment industry, to provide systems by which a rendering device can possess active and inactive modes. Clearly, a rendering device consumes more energy during an active state than an inactive state. In many cases, the warm-up time of a rendering device is itself a major consumer of time and energy, and therefore there is a desire to lessen the number of times a rendering device is requested to “wake up” in the course of a day.

Among possible software aspects required by the rendering device may be a need for an internal processor to “boot up” or otherwise become active; or for an interpreter or equivalent program to process incoming image data to make the data directly useable by the hardware. Among possible hardware aspects are the activation of any number of motors or drives, such as drawing a print sheet into a position to receive an image. In the case of xerographic or electrostatographic printers, for example, there is typically an appreciable “warm-up” time in which a fuser is brought to a necessary temperature, and/or a charging device is brought to a necessary potential. The fuser is the part of a laser printer which melts the toner onto the printing medium. Since it is normal for an office printer to have more capacity than its usage, it is often the case that the printer will be idle when the rendering job (e.g., print job) arrives. In order to save energy, typical rendering devices in the idle state reduce power to the fuser. Although reducing power to the fuser will save energy, one problem encountered is that the user must then wait for the fuser to heat up before any printing can be performed.

In the case of an ink-jet printer, there is typically a warm-up time in which, for instance, lines or channels for conveying liquid ink are primed, or a solid ink stick is partially melted to yield a useable quantity of liquid ink. In the case of an input scanner, which is usually part of a digital copier, there is typically a necessary warm-up time for an illumination lamp to reach a necessary luminescence.

Various methods have been implemented for managing the queuing of rendering jobs. One example is disclosed in U.S. Patent Application Number 2007/0146772, entitled “Autonomous Decision-making in Print Job Redirection” by Castellani and is assigned to the Xerox Corporation of Stamford, Conn. U.S. Patent Application Number 2007/0146772, which is incorporated herein by reference in its entirety, discloses a rendering job management method which redirects rendering jobs to a different printer if a printer is unable to execute a print job.

Another example of a rendering job management method is disclosed in U.S. Patent Application Number 2007/0047993, by Brinsley and is assigned to the Xerox Corporation of Stamford, Conn. U.S. Patent Application Number 2007/0047993, which is incorporated herein by reference in its entirety, discloses a rendering job management method wherein the digital printer delays beginning switching from the inactive mode to the active mode, for a delay period of predetermined duration. In response to receiving a second rendering request during the delay period, the digital printer begins switching from the inactive mode to the active mode substantially immediately. The delay increases opportunities for processing multiple print requests with only one rendering device switching to the active mode.

Some current rendering job management methods focus on the wait time for the rendering by the selection of a rendering device on a network which is currently idle. Current network rendering management and queuing methods send the rendering job to an idle rendering device if another rendering device on the network is busy. When a rendering job is sent to an idle rendering device, the rendering device will typically begin to process and print the document after the fuser warm-up time has passed. This occurs without consideration of the energy required to heat the fuser during the warm-up period. Another rendering job management technique involves sending the job to specifically located printers (e.g., located in the same room of an office, or to printers located on the same floor of an office building). These methods may result in multiple printers being in the warm-up mode simultaneously or warming-up while another printer still has a fuser that is heated, thereby reducing the energy efficiency.

The solution described herein therefore reduces the energy required by multiple rendering devices in a network by directing a rendering job to a rendering device that is, or has recently been busy, thereby reducing the number of rendering devices that are in a warm-up phase or are active.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved method for queuing of rendering jobs on a network.

It is another aspect of the present invention to provide for an energy saving method of redirection and queuing of rendering jobs on a network.

The aforementioned aspects and other objectives and advantages can now be achieved as described herein. A plurality of rendering devices in communication with a network can be configured with an active mode and an inactive mode wherein in the active mode a rendering device is either printing or comprises components ready to render. In response to receiving a rendering job request it is determined if any rendering device of the plurality of rendering devices is currently an active mode rendering device. If there is an active mode rendering device with respect to the network, a rendering queue wait time is estimated with respect to the active mode rendering device and an activation wait time is estimated for an inactive rendering device available via the network. The estimated rendering queue wait time can be compared to the estimated activation wait time and the rendering job can be rendering on the rendering device associated with a shorter estimated time thereby saving energy by maintaining the majority of rendering devices on the network in an inactive mode.

According to one embodiment, the current invention directs a rendering job to a rendering device in a network with a plurality of available rendering devices, that is, or has recently been busy, thereby directing the rendering job to a rendering device with a currently heated fuser. This thereby reduces the cycle up time needed to heat the fuser on the designated rendering device allowing other network rendering to remain in the idle mode for a longer period of time.

Multiple strategies are possible which reduce the energy required depending upon various selectable embodiments by a network manager. In one possible embodiment, a rendering job could be directed to a currently busy rendering device if the time estimated to complete the current job is less than the time estimated to warm-up an idle rendering device on the network. If the rendering queue exceeds this time estimate, the rendering job could be sent to an idle machine. This strategy would result in energy savings, but with a minimum response time by maintaining a modest queue of jobs for one of the rendering devices. With this method, the active rendering device can maintain a hot fuser and avoid the cycle up and down times. Other rendering devices on the network can handle the overloads and remain in the idle or sleep mode for longer periods of time.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a simplified view of a rendering device (e.g., copier/printer, etc.), which can be adapted for use in accordance with a preferred embodiment;

FIG. 2 illustrates an exemplary network, which can be implemented in accordance with a preferred embodiment;

FIG. 3 illustrates a high level flow chart of operations depicting logical operational steps of an energy saving redirection and queuing method, which can be implemented in accordance with a preferred embodiment; and

FIG. 4 illustrates a high level flow chart of operations depicting logical operational steps of an energy saving redirection and queuing method, which can be implemented in accordance with an alternate embodiment.

### DETAILED DESCRIPTION

The particular values and configurations discussed in these non-limiting examples can be varied and are cited merely to illustrate at least one embodiment and are not intended to limit the scope thereof.

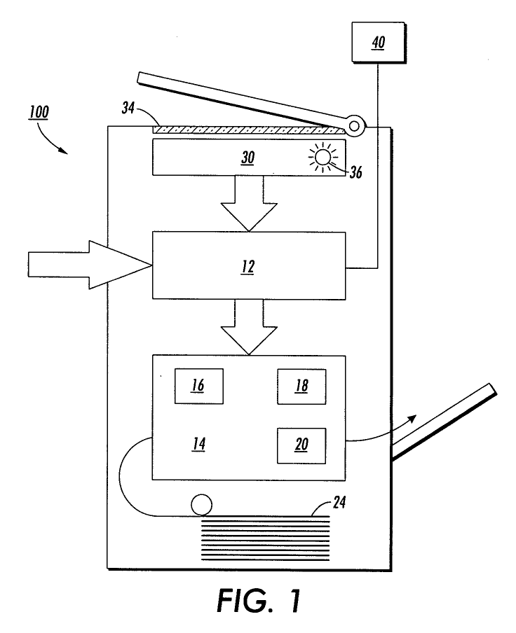

FIG. 1 is a simplified view of a rendering device 100, which may be adapted for use in accordance with one or more embodiments. As used herein, the word “rendering device” shall apply to any machine that outputs rendering jobs based on image data from any source, including copiers, facsimile machines, and multi-function devices. Examples of such rendering devices include laser printers, scanners, copiers, and the like. The rendering device 100 depicted in FIG. 1 generally includes a control system 12, which accepts image data from an external source, such as a network. Control system 12 can include components, such as a memory for retaining image data when multiple rendering jobs (e.g., printing) or other rendering requests are entered into the control system 12. Control system 12 typically includes one or more processors, along with ancillary chips, such as for additional memory capabilities. Such processors may require an appreciable amount of time to “boot up” or otherwise become able to process data.

Control system 12 is operative of what can generally be called a “print engine” 14, that can be of any type familiar in the art of office equipment. A print engine can be defined as any hardware that can be controlled to create a desired image on a sheet. Most types of print engines include at least one motor, such as for moving a sheet relative to the print engine; such a motor is indicated in a general form as 16. Motor 16 can be generally considered to be able to position a sheet drawn from a media stack 24 such as to receive an image from the print engine 14. If the print engine 14 is xerographic, the engine will further include at least one device or member 18, such as a corona device, development unit, or transfer device, which must be brought to a predetermined potential in order to operate. If the print engine 14 is of another type, such as ink-jet of some type, there is typically some heating device 20, which must be brought to a predetermined temperature to operate. In a typical xerographic printer, for example, the heating device 20 may be implemented in the form of a fuser.

Also associated with control system 12 is a scanner 30, for recording image data from a hard-copy original such as placed on a platen 34. Many scanners include an illumination lamp 36, which must reach a certain brightness level in order to operate. The image data recorded at scanner 30 is retained within control system 12, for substantially instant printing through print engine 14, when the rendering device 100 is operating as a copier. Rendering device 100 includes a user interface 40 by which a user near the rendering device can enter commands.

As mentioned above, various hardware elements of a rendering device 100, such as motor 16, charge device 18, heating device 20, and/or illumination device 36, require an appreciable amount of time to change from an “inactive” mode to an active mode, in which the elements are ready for outputting prints. It is known in the art of office equipment to control a rendering device to operate in what is generally called a “sleep” or “energy-saving” mode, in which, the fuser or other charged members, are shut down. When a rendering job is subsequently sent to the rendering device 100, the rendering device must activate and the fuser and charge devices must literally “warm up”. To warm up from sleep mode typically takes an activation wait time on the order of one to two minutes. As used herein, the term “active”. when referring to a rendering device shall mean that the rendering device has received at least one rendering job, that the rendering device has warmed-up the fuser or other components or has so recently warmed-up that the rendering device is usable without an appreciable warm-up time. As further used herein, the terms “inactive”, “sleep”, and “idle” shall all be interchangeable and shall refer to a rendering device which requires an appreciable warm-up time of the fuser or other rendering device components.

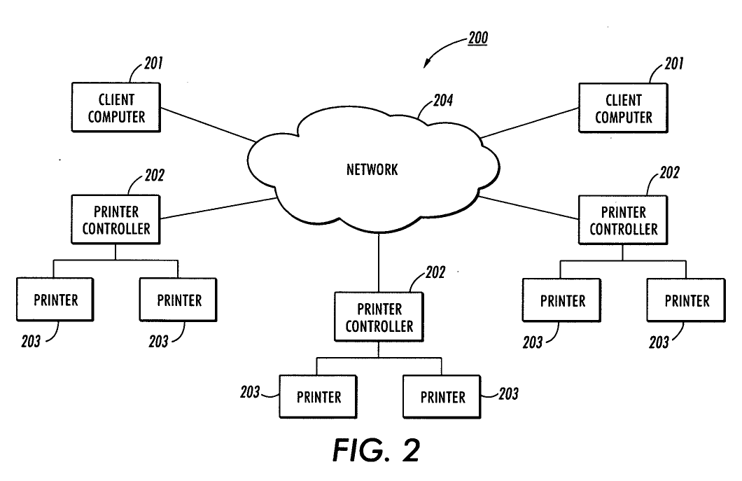

FIG. 2 illustrates an exemplary network system 200 in which the present invention may be implemented in accordance with a preferred embodiment. System 200 includes a plurality of client computers 201, rendering device controllers 202, and rendering device(s) 203. These components communicate via network 204. The rendering device controllers 202 can be provided as computers with memory and other components that operate under the control of programmed instructions to communicate with the client computers 201 and to manage the rendering device(s) 203 coupled to each controller. Each controller may have one or more logical or virtual rendering devices (e.g., virtual printers) executing in it for processing rendering jobs received from the client computers. logical rendering devices can process a rendering job data file to transform, for example, a rendering job data file into an image file or the rendering device may use a daemon for that purpose. The network 204 coupling the controllers and client computers may be comprised of any suitable network architecture, such as LAN, Ethernet, WAN, System Area Network (SAN), Token Ring, LocalTalk, or TCP/IP network schemes. Such a network may be used, for example, in a document production environment in which the client computers are operator workstations for sending rendering jobs to rendering device controllers on a network.

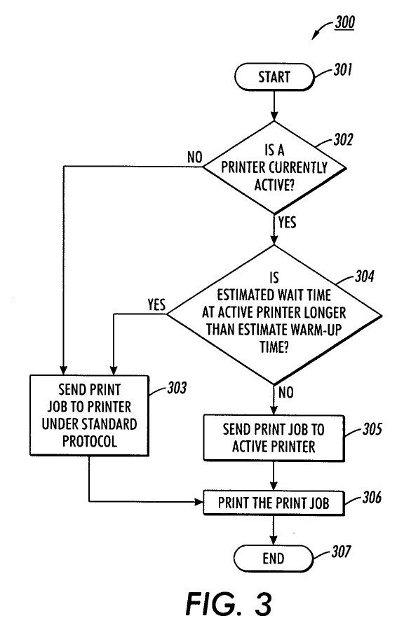

FIG. 3 illustrates a high level flow chart of operations depicting logical operational steps of an energy saving redirection and queuing method 300, which can be implemented in accordance with a preferred embodiment. The process begins as depicted at block 301 by sending a rendering job to the network rendering device controllers 202. The next step, as indicated at block 302, involves determining if a rendering device 203 in communication with the network 204 is currently active; i.e., it must be determined if a rendering device 203 is currently printing another rendering job or if the rendering device is still in the active mode from an earlier rendering job. If it is determined that there is not a rendering device 203 which is active, then the rendering job is sent to a rendering device 203 based on a network rendering device selection protocol chosen by a network administrator, as depicted at block 303. The rendering job is then printed as depicted at block 306 and the steps terminate as indicated at block 307. The network rendering device selection protocol chosen by a network administrator could be any selection criteria as to which rendering device will print the rendering job. The network rendering device selection protocol, as depicted at block 303, should select the rendering device 203 that the network administrator has chosen to print most of the jobs on the network. Some non-limiting examples of a rendering device selection protocols may be the closest rendering device, a rendering device on the same floor as the user which sent the rendering job, the fastest rendering device, the least expensive rendering device, or a random rendering device in the network system 200. The selection of a rendering device 203, when it is determined that there is not an active rendering device 203, is based on choices that a network administrator makes and is similar to the network rendering device selection protocols currently in use.

Alternatively, if it is determined at block 302 that a rendering device 203 is active, the operation proceeds to the next step, as depicted at block 304. In this embodiment, an estimation of the print queue wait time is made and compared to the estimated warm-up time of an inactive rendering device 203 on the network system 200. If the estimation of the print queue wait time is longer that the estimated warm-up time of an inactive rendering device, the rendering job is then sent to a rendering device based on a rendering device selection protocol chosen by a network administrator, as depicted at block 303. If the comparison of the estimated print queue wait time to the estimated warm-up time of an inactive rendering device shows that the queue wait time is less than the warm-up time, then, as depicted at block 305, the rendering job is sent to the active rendering device 203. The rendering job is then printed, as indicated at block 306 and the operational steps terminate as indicated at block 307.

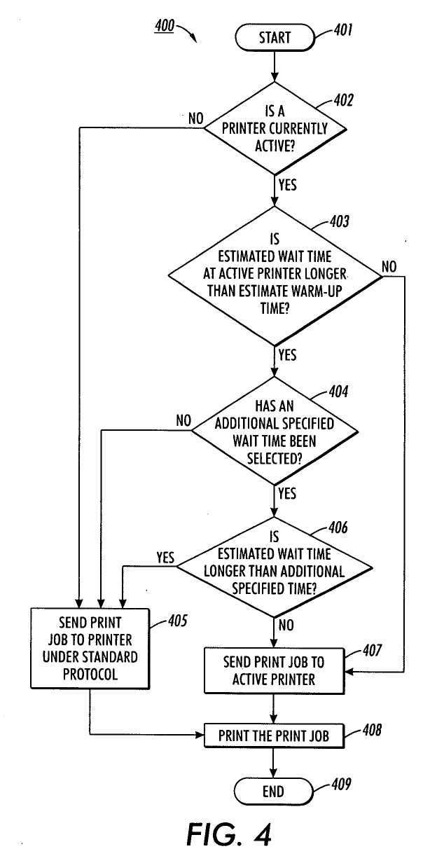

FIG. 4 illustrates a high level flow chart of operations depicting logical operational steps of an energy saving redirection and queuing method 400 in an alternate embodiment. The operation is started as depicted at block 401 by sending a rendering job to the network rendering device controllers 202. The next step, as indicated at block 402, must be to determine if there is a rendering device 203 on the network 204 which is currently active; i.e. it must be determined if a rendering device 203 is currently printing another rendering job or if the rendering device is still in the active mode from an earlier rendering job. If it is determined that there is not a rendering device 203 which is active, then the rendering job is sent to a rendering device 203 based on a rendering device selection protocol chosen by a network administrator, as depicted at block 405. The rendering job is then printed as depicted at block 408 and the steps terminate as indicated at block 409. Some non-limiting examples rendering device selection protocols may include the closest rendering device, a rendering device on the same floor as the user which sent the rendering job, or a random rendering device in the network system 200. The selection of a rendering device 203, when it is determined that there is not an active rendering device 203, is based on choices that a network administrator makes and is similar to the selection protocols currently in use.

Alternatively, if it is determined at block 402 that a rendering device 203 is active, the operation proceeds to the next step, as depicted at block 403. In this embodiment, an estimation of the print queue wait time is made and compared to the estimated warm-up time of an inactive rendering device 203 on the network system 200.

If the comparison of the estimated rendering queue wait time to the estimated warm-up time of an inactive printer shows that the queue wait time is less than the warm-up time, then, as depicted at block 403, the rendering job is sent to the active rendering device 203, as depicted in block 407. The rendering job is then printed, as indicated at block 408 and the operational steps terminate as indicated at block 409.

If the comparison of the estimated rendering queue wait time to the estimated warm-up time results in an estimated queue wait time longer than the warm-up time, then, as depicted at block 404, it is determined if a specified wait time has been selected. A network administrator may select an additional time period to add to the estimated print queue wait time. This results in additional energy savings over sending the rendering job to an inactive rendering device at the cost of a longer wait time for a user. A network administrator may choose a reasonable wait longer wait time based on individual preferences. In an additional embodiment the additional wait time may be specified on a per-job basis. For low-priority jobs, high wait times can be given to increase the probability that they will be sent to an active device, while for high-priority jobs, a low wait time can be specified so that they are printed quickly, regardless of energy cost. A number of possible criteria may be used for determining the job priority and corresponding wait time. The criteria may, for example, be set by the job submitter, or alternatively the network administrator may establish a policy whereas the jobs from one department may have a higher priority from those of a different department, or that large jobs may have higher priority than small ones. For maximum energy savings, the network administrator or user may select a time limit beyond which the print queue wait time is intolerable. If this additional specified wait time has not been selected, then as depicted at block 405, the rendering job is sent to an inactive rendering device under a standard protocol. The rendering job is then printed as depicted at block 408 and the steps terminate as indicated at block 409. Some non-limiting examples of a rendering device selection protocols may be the closest rendering device, a rendering device on the same floor as the user which sent the rendering job, or a random rendering device in the network system 200. The selection of a rendering device 203, when it is determined that there is not an active rendering device 203, is based on choices that a network administrator makes and is similar to the selection protocols currently in use.

The determination that a specified additional wait time has been selected, as indicated at block 404, results in an additional determination at block 406 as to whether the estimated print queue wait time exceeds the additional specified wait time. If the print queue wait time does exceed the additional specified wait time, then as indicated at block 405, the rendering job is sent to an inactive rendering device. If, however, the estimated print queue wait time is less than the specified additional wait time, then as depicted at block 407, the rendering job is sent to the active rendering device to be printed in the queue. The rendering job is then printed, as depicted at block 408 and the operational steps end as depicted at block 409. The greatest energy savings would be achieved in this embodiment with all rendering jobs sent to a single printed until the additional specified wait time is exceeded. The utilization of the operational steps depicted in FIGS. 3 and 4 may result in one rendering device rendering a majority of the documents to be rendered (e.g., printed), leaving the remainder of the rendering devices to handle the rendering device job overload. It should be appreciated that the methods of FIGS. 3 and 4 may include additional rules or restrictions. For example, one might restrict the set of devices considered for rendering to only those within a certain distance from the user, or one might adjust the specified wait times according to the time of day to insure that rendering jobs are completed by certain specified times in the work day, for example, such as an end of a work day.

It can be appreciated that the operational steps depicted in FIGS. 3 and 4 generally represent operations that may be utilized in accordance with a variety of embodiments. Such operational steps can be utilized to implement methods, systems and program products thereof. Such operational steps may also be implemented in the form of software modules. Such modules are generally collections of routines and data structures that perform particular tasks or implement particular abstract data types and/or instructions for processing via a processor and/or other data-processing device wherein the software module may be embodied on a data-processing storage device. Modules are typically composed of two portions: an interface, which lists constants, data types, variables, routines, subroutines, and so forth, which may be accessed by other modules, routines, or subroutines; and an implementation, which is accessible only to the module and which contains source code that actually implements the routines in the module.

Modules generally are composed of two parts. First, a software module may list the constants, data types, variable, routines and the like that that can be accessed by other modules or routines. Second, a software module can be configured as an implementation, which can be private (i.e., accessible perhaps only to the module), and that contains the source code that actually implements the routines or subroutines upon which the module is based. Thus, for example, the term module, as utilized herein generally refers to software modules or implementations thereof. Such modules can be utilized separately or together to form a program product that can be implemented through signal-bearing media, including transmission media and recordable media. Thus, for example, the operational steps depicted in FIGS. 3 and 4 as flow charts 300 and 400 can be implemented as modules in a data-processing system or in a rendering device controller for the redirection and queuing of rendering jobs for energy savings in a network with a plurality of available rendering devices.

It can be appreciated that various other alternatives, modifications, variations, improvements, equivalents, or substantial equivalents of the teachings herein that, for example, are or may be presently unforeseen, unappreciated, or subsequently arrived at by applicants or others are also intended to be encompassed by the claims and amendments thereto.

1. A method, comprising:
selecting a document to be rendered by any rendering device among a plurality of rendering devices in communication with a network, such that each rendering device among said plurality of rendering devices comprises an active mode and an inactive mode, in order to determine if said any rendering device among said plurality of rendering devices constitutes an active mode rendering device in said active mode;
estimating a rendering queue wait time of said active mode rendering device in response to determining if said any rendering device among said plurality of rendering devices constitutes said active mode rendering device in said active mode and estimating an activation wait time for an inactive rendering device among said plurality of rendering devices; and
thereafter associating said rendering queue wait time with said active mode rendering device and associating said activation wait time with said inactive printer in order to create an energy saving redirection and an orderly queuing of rendering jobs.

2. The method of claim 1 further comprising:
comparing said activation wait time for said inactive rendering device of said plurality of rendering devices to said rendering queue wait time of said active mode rendering device to determine a shorter wait time between said rendering queue wait time and said activation wait time.

3. The method of claim 2 further comprising:
rendering said document on one rendering device among said plurality of rendering devices wherein said one rendering device is associated with said shorter wait time.

4. The method of claim 1 further comprising:
rendering said document on one rendering device among said plurality of rendering devices.

5. The method of claim 1 wherein said active mode rendering device is either rendering another document or comprises components ready to render said document.

6. The method of claim 1 wherein said inactive rendering device comprises components requiring said activation wait time.

7. The method of claim 1 further comprising:
rendering said document on said inactive rendering device if it is determined that none of said plurality of rendering devices constitutes said active mode rendering device in said active mode.

8. The method of claim 7 further comprising:
selecting said inactive rendering device from said plurality of rendering devices utilizing a selection protocol selected from a plurality of selection protocols.

9. A method comprising:
selecting a document to be rendered by any rendering device among a plurality of rendering devices in communication with a network, such that each rendering device among said plurality of rendering devices comprises an active mode and an inactive mode, in order to determine if said any rendering device among said plurality of rendering devices constitutes an active mode rendering device in said active mode;
estimating a rendering queue wait time of said active mode rendering device in response to determining if said any rendering device among said plurality of rendering devices constitutes said active mode rendering device in said active mode; and
selecting a specified wait time and thereafter associating said rendering queue wait time with said active mode rendering device and associating said specified wait time with said inactive rendering device in order to create an energy saving redirection and an orderly queuing of rendering jobs.

10. The method of claim 9 wherein said active mode rendering device is either rendering another document or comprises components ready to render said document.

11. The method of claim 10, further comprising:
comparing said rendering queue wait time to said specified wait time and thereafter selecting a shorter time between said rendering queue wait time and said specified wait time; and
rendering said document on one rendering device among said plurality of rendering devices.

12. The method of claim 11, further comprising:
rendering said document on said inactive rendering device if it is determined that said specified wait time is shorter than said rendering queue time.

13. The method of claim 12, further comprising:
rendering said document on said active rendering device if it is determined that said rendering queue wait time is shorter than said specified wait time.

14. The method of claim 13 wherein said inactive rendering device comprises components requiring said activation wait time.

15. The method of claim 14 further comprising:
rendering said document on said inactive rendering device if it is determined that none of said plurality of rendering devices constitutes said active mode rendering device in said active mode.

16. The method of claim 15 further comprising:
selecting said inactive rendering device from said plurality of rendering devices utilizing a selection protocol selected from a plurality of selection protocols.

17. A system comprising:
at least one data-processing device having a data-processor readable software code embodied on a storage device of said data-processing device, said data-processor readable software code programmed to perform a method comprising the steps of:
selecting a document to be rendered by any rendering device among a plurality of rendering devices in communication with a network, such that each rendering device among said plurality of rendering devices comprises an active mode and an inactive mode, in order to determine if said any rendering device among said plurality of rendering devices constitutes an active mode rendering device in said active mode;
estimating a rendering queue wait time of said active mode rendering device in response to determining if said any rendering device among said plurality of rendering devices constitutes said active mode rendering device in said active mode and estimating an activation wait time for an inactive rendering device among said plurality of rendering devices; and
thereafter associating said rendering queue wait time with said active mode rendering device and associating said activation wait time with said inactive printer in order to create an energy saving redirection and an orderly queuing of rendering jobs.

18. The system of claim 17 wherein said data-processor readable software code is further programmed to perform the step of:
comparing said activation wait time for said inactive rendering device of said plurality of rendering devices to said rendering queue wait time of said active mode rendering device to determine a shorter wait time between said rendering queue wait time and said activation wait time.

19. The system of claim 18 wherein said data-processor readable software code is further programmed to perform the step of:
rendering said document on one rendering device among said plurality of rendering devices wherein said one rendering device is associated with said shorter wait time.

20. The system of claim 19 wherein said data-processor readable software code is further programmed to perform the steps of:
rendering said document on said inactive rendering device if it is determined that none of said plurality of rendering devices constitutes said active mode rendering device in said active mode; and
selecting said inactive rendering device from said plurality of rendering devices utilizing a selection protocol selected from a plurality of selection protocols.
